(19) United States
(12) Patent Application Publication
(10) Pub. No.: US 2013/0332695 A1
(43) Pub. Date: Dec. 12, 2013

(54) INFORMATION PROCESSING APPARATUS AND METHOD AND COMPUTER-READABLE MEDIUM

(71) Applicant: Sony Corporation, Tokyo (JP)

(72) Inventors: Tomohiro KATORI, Tokyo (JP); Tetsuya Asayama, Tokyo (JP); Katsuya Takahashi, Kanagawa (JP); Hiroki Nagahama, Tokyo (JP); Nobuhiro Kaneko, Kanagawa (JP)

(73) Assignee: Sony Corporation, Tokyo (JP)

(21) Appl. No.: 13/894,561

(22) Filed: May 15, 2013

(30) Foreign Application Priority Data
Jun. 8, 2012 (JP) 2012-130397

(51) Int. Cl. G06F 12/02

(52) U.S. Cl. CPC G06F 12/023
USPC 711/172

(57) ABSTRACT

There is provided an information processing apparatus including a primary storage apparatus configured by combining a plurality of memories each having a different upper limit of a number of possible rewrites, and an allocation management section configured to allocate a storage area of data to be stored in the primary storage apparatus to one of the plurality of memories based on a rewrite frequency of the data.

### BACKGROUND

The present technology relates to an information processing apparatus and method and a computer-readable medium, and more particularly to an information processing apparatus and method and a computer-readable medium for enabling a memory to be more efficiently used.

Recently, the development of nonvolatile memories is ongoing.

For example, a magnetoresistive random access memory (MRAM) is memory technology using the same magnetic material as a hard disk for a storage medium. An MRAM uses an effect of tunnel magnetoresistance (TMR) in which a resistance value is varied by sandwiching an insulator thin film having a thickness of about several atoms between magnetic thin films of two layers and varying magnetization directions applied from both sides.

For an MRAM, an address access time is about 10 ns, a cycle time is about 20 ns, and reading/writing can be performed at a speed about five times faster than that of a dynamic random access memory (DRAM). In addition, there is an advantage in that low power consumption of about 1/10 of a flash memory and high integration are possible.

In addition, a resistance random access memory (ReRAM) uses a large change in electric resistance due to voltage application (a large resistance change in electric field induction or an effect of colossal electro-resistance (CER)).

A ReRAM has a small cell area because of a relatively simple structure and hence a high density (=low cost) can be formed. In addition, because a change rate in electric resistance is increased by a factor of several tens and multi-value is easily formed, a large capacity can be expected.

On the other hand, there is an upper limit for the number of rewrites in the above-described nonvolatile memories. That is, it is difficult to perform rewriting in an individual storage area a given number of times or more. The upper limit of the number of rewrites is referred to as rewrite life. In a system or the like using the above-described nonvolatile memory, the management of the rewrite life is important.

For example, a scheme of recording the number of possible rewrites for each page within a memory having a rewrite life, updating the number of possible rewrites for every rewrite, and moving stored contents to another page when the number of possible rewrites becomes zero has been proposed (for example, see JP 2010-186477A).

### SUMMARY

Incidentally, the rewrite life of a nonvolatile memory differs according to a type of memory. For example, the MRAM has a relatively long rewrite life, and the ReRAM has a relatively short rewrite life. On the other hand, compared to the MRAM, the ReRAM can increase a storage capacity at a low cost.

However, for example, in the technology of JP 2010-186477A, a rewrite corresponding to a type of memory is not considered. For example, the management of rewrite life is expected in a system using a plurality of types of memories each having a different rewrite life or the like.

It is desirable to more efficiently use a memory.

According to an embodiment of the present disclosure, there is provided an information processing apparatus including a primary storage apparatus configured by combining a plurality of memories each having a different upper limit of a number of possible rewrites, and an allocation management section configured to allocate a storage area of data to be stored in the primary storage apparatus to one of the plurality of memories based on a rewrite frequency of the data.

The allocation management section may allocate a storage area of data having a high rewrite frequency to a first memory of the plurality of memories. The allocation management section may allocate a storage area of data having a low rewrite frequency to a second memory having a smaller upper limit of the number of possible rewrites than the first memory of the plurality of memories.

The allocation management section may set a storage capacity per page of the second memory to be larger than a storage capacity per page of the first memory.

The second memory may have a larger storage capacity than the first memory.

The first memory may be a magnetoresistive random access memory (MRAM). The second memory may be a resistance random access memory (ReRAM) or a phase change memory (PCM).

The information processing apparatus may further include a rewrite frequency estimation section configured to estimate a rewrite frequency of data to be stored in the primary storage apparatus based on additional information of the data.

The rewrite frequency estimation section may estimates a rewrite frequency of a part included in data to be stored in the primary storage apparatus for a data type of the data.

The rewrite frequency of the part included in the data may be estimated based on a template generated by learning for the data type of the data.

The information processing apparatus may further include a specific step execution notification section configured to notify the allocation management section that a specific step is executed when a process of the specific step designated in advance is executed in a program to be executed by a central processing unit (CPU). When the notification has been received from the execution notification section, the allocation management section may allocate the storage area of the data allocated to one memory among the plurality of memories to another memory among the plurality of memories.

When the notification has been received from the execution notification section, the allocation management section may allocate a storage area of data stored in the second memory having a smaller upper limit of the number of possible rewrites than the first memory of the plurality of memories, to the first memory.

A memory having a relatively small upper limit of the number of possible rewrites of the plurality of memories may also be used as an auxiliary storage apparatus.

A memory having a relatively small upper limit of the number of possible rewrites of the plurality of memories may be configured as a nonvolatile memory. A memory having a relatively large upper limit of the number of possible rewrites of the plurality of memories may be configured as a volatile memory.

According to an embodiment of the present disclosure, there is provided an information processing method of an information processing apparatus including a primary storage apparatus configured by combining a plurality of memories each having a different upper limit of a number of possible rewrites, the information processing method including allocating a storage area of data to be stored in the primary storage apparatus to one of the plurality of memories based on a rewrite frequency of the data.

According to an embodiment of the present disclosure, there is provided a non-transitory computer readable medium having a computer readable instructions stored thereon that when executed by an information processing apparatus including a primary storage apparatus configured by combining a plurality of memories each having a different upper limit of a number of possible rewrites perform a method, the method including allocating a storage area of data to be stored in the primary storage apparatus to one of the plurality of memories based on a rewrite frequency of the data.

According to an embodiment of the present disclosure, a primary storage apparatus is configured to combine a plurality of memories each having a different upper limit of a number of possible rewrites in a manner that a storage area of data to be stored in the primary storage apparatus is allocated to one of the plurality of memories based on a rewrite frequency of the data.

According to the embodiments of the present technology described above, a memory can be more efficiently used.

### BRIEF DESCRIPTION OF THE DRAWINGS

FIG. 1 is a block diagram illustrating a configuration example of a calculation processing system;

FIG. 2 is a block diagram illustrating a functional configuration example of software such as a program to be executed by a central processing unit (CPU) and a memory management unit (MMU) of FIG. 1;

FIG. 3 is a diagram illustrating association of data with a virtual address space and a physical address space;

FIG. 4 is a block diagram illustrating another functional configuration example of software such as a program to be executed by the CPU and the MMU of FIG. 1;

FIG. 5 is a diagram illustrating a difference of a capacity per page between a long-lived memory and a short-lived memory;

FIG. 6 is a block diagram illustrating still another functional configuration example of software such as a program to be executed by the CPU and the MMU of FIG. 1;

FIG. 7 is a block diagram illustrating still another functional configuration example of software such as a program to be executed by the CPU and the MMU of FIG. 1;

FIG. 8 is a flowchart illustrating an example of a memory write process;

FIG. 9 is a flowchart illustrating another example of the memory write process;

FIG. 10 is a flowchart illustrating an example of a rewrite frequency estimation process;

FIG. 11 is a flowchart illustrating an example of a data movement control process; and

FIG. 12 is a block diagram illustrating a configuration example of a personal computer (PC).

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

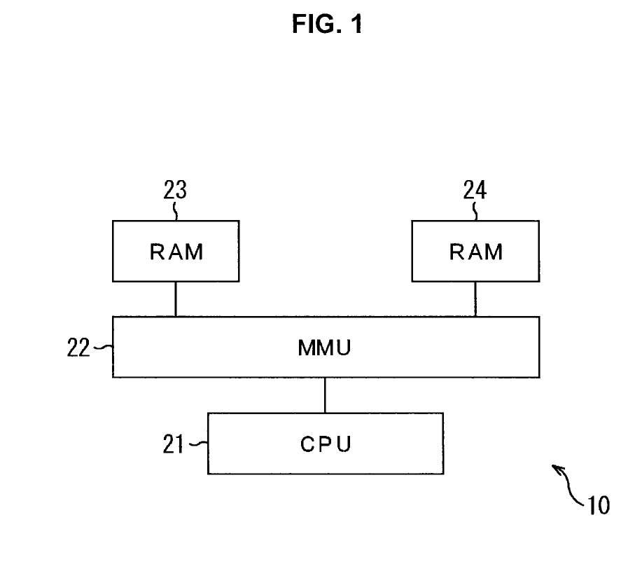

FIG. 1 is a block diagram illustrating a configuration example of a calculation processing system.

The calculation processing system 10 illustrated in FIG. 1 includes a CPU 21, an MMU 22, a random access memory (RAM) 23, and a RAM 24. The calculation processing system 10, for example, is formed in a portable telephone device, a smart phone, or the like, and is configured to execute a downloaded application program or the like.

Here, the RAM 23 serves as a memory in which a rewrite life is long (an upper limit of the number of possible rewrites is large) and the RAM 24 serves as a memory in which a rewrite life is short (an upper limit of the number of possible rewrites is small). Also, the RAM 23 is arbitrarily referred to as a long-lived memory and the RAM 24 is referred to as a short-lived memory.

Although the long-lived memory has an advantage in that the upper limit of the number of possible rewrites is large, there is a disadvantage in that it is difficult to form a high density and a large capacity. In addition, although the short-lived memory has a disadvantage in that the upper limit of the number of possible rewrites is small, there is an advantage in that a high density is easily formed and a large capacity is easily formed.

The calculation processing system 10 is set to configure a primary storage apparatus by combining the long-lived memory and the short-lived memory having the above-described advantage and disadvantage.

The RAM 23, for example, includes an MRAM or the like. The RAM 24 includes a ReRAM, a phase change memory (PCM), or the like.

The RAM 23 and the RAM 24 are provided as a primary storage apparatus (main memory) corresponding to the CPU 21, and data is set to be written or read based on control of the MMU 22. The MMU 22 has functions related to conversion of a virtual address and a physical address, memory protection, and the like, and serves as a functional block that executes a process related to memory access control of the CPU 21. The MMU 22 may be configured as part of the CPU 21.

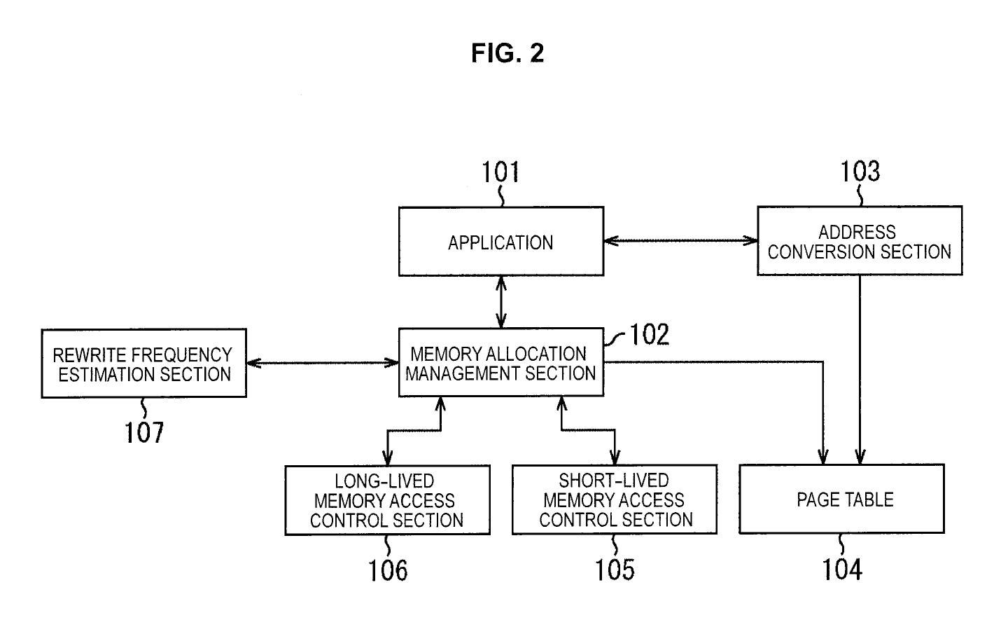

FIG. 2 is a block diagram illustrating a functional configuration example of software such as a program to be executed by the CPU 21 and the MMU 22 of FIG. 1.

In FIG. 2, an application 101 serves as a process in which a downloaded application program or the like is executed, and outputs a command of reading, writing, or the like of a file or the like necessary during processing to a memory allocation management section 102.

For example, when data necessary during processing is read from the RAM 23 or the RAM 24, the application 101 supplies a virtual address, which specifies a storage position of data included in a corresponding file, to an address conversion section 103, and requests conversion of the virtual address into a physical address.

The address conversion section 103 converts the virtual address supplied from the application 101 into the physical address based on a page table 104. Thereby, the application 101 acquires the physical address related to the data, and outputs an access request for the physical address to the memory allocation management section 102.

The memory allocation management section 102 is a storage area corresponding to the physical address supplied from the application 101, and controls reading of data from a storage area of the RAM 23 or 24. When a file is read from the storage area of the RAM 23, the memory allocation management section 102 outputs a read request to a long-lived memory access control section 106. In addition, when data is read from the storage area of the RAM 24, the memory allocation management section 102 outputs the read request to a short-lived memory access control section 105.

The long-lived memory access control section 106 is set to read data from a predetermined storage area of the RAM 23, and the short-lived memory access control section 105 is set to read data from a predetermined storage area of the RAM 24.

On the other hand, for example, when a file or the like generated during processing is written to the RAM 23 or 24, the application 101 outputs a write request to the memory allocation management section 102. At this time, the application 101, for example, is set to add a label related to a rewrite frequency of corresponding data to a header or the like of the data included in the file.

The memory allocation management section 102 allocates a storage area corresponding to a size of the data included in the file for which writing has been requested from the application 101 to the RAM 23 or 24. At this time, the memory allocation management section 102 queries a rewrite frequency estimation section 107 for a rewrite frequency so as to determine to which of the RAMs 23 and 24 the storage area of the data should be allocated.

The rewrite frequency estimation section 107 determines (estimates) whether the rewrite frequency of the data is high (the frequency is high) or low (the frequency is low) by referring to the label added to the header of the data, and notifies the memory allocation management section 102 of the determination (estimation) result.

When the rewrite frequency of the notification from the rewrite frequency estimation section 107 is large, the memory allocation management section 102 allocates the storage area of the data to the RAM 23, which is the long-lived memory. Therefore, the memory allocation management section 102 causes the RAM 23 to store the data via the long-lived memory access control section 106.

In addition, when the rewrite frequency of the notification from the rewrite frequency estimation section 107 is low, the memory allocation management section 102 allocates the storage area of the data to the RAM 24, which is the short-lived memory. Therefore, the memory allocation management section 102 causes the RAM 24 to store the data via the short-lived memory access control section 105.

Further, as described above, the memory allocation management section 102 updates information of the page table 104 in which a physical address, which specifies a storage area of the data allocated to the RAM 23 or 24, and a virtual address to be referred to by the application 101 are associated.

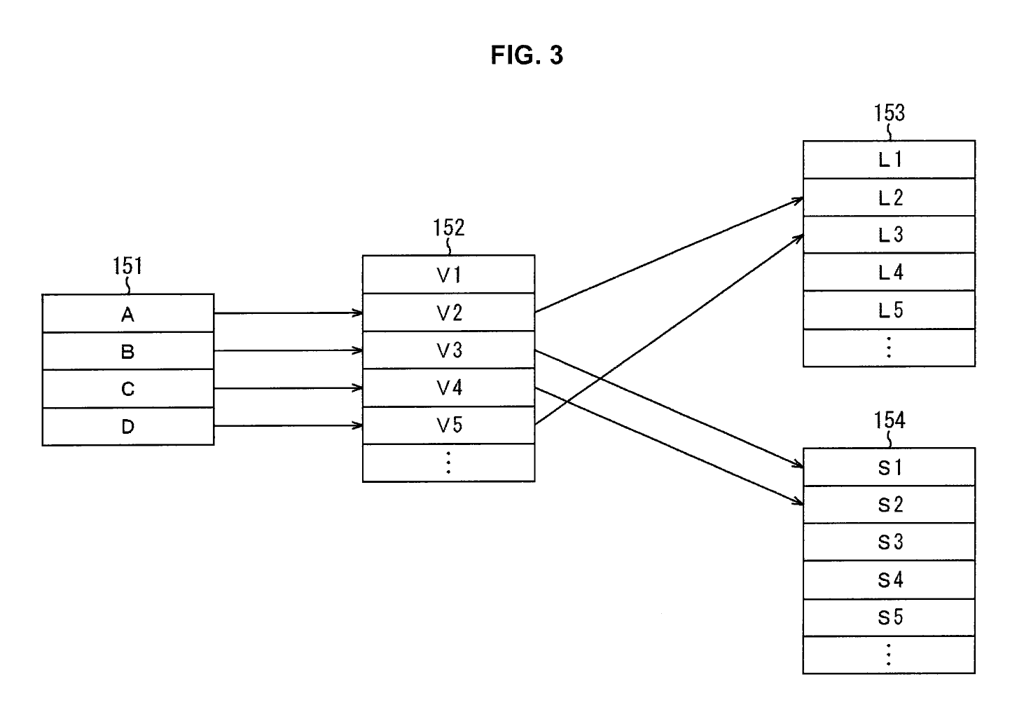

For example, as illustrated in FIG. 3, a file 151 generated during processing in the application 101 is assumed to include data A to D. Here, it is assumed that rewrite frequencies of the data A and the data D are large and rewrite frequencies of the data B and the data C are low.

The data A to D included the file 151 is mapped to addresses V2 to V5, respectively, in a virtual address space 152 having an address V1, the address V2, the address V3, the address V4, the address V5, . . .

As described above, the data A and D is stored in the RAM 23, which is the long-lived memory, because the data A and D has a high rewrite frequency. A physical address space 153 of the long-lived memory has an address L1, an address L2, an address L3, an address L4, an address L5, . . . Here, it is assumed that the physical address which specifies the storage area in which the data A is stored is the address L2 and the physical address which specifies the storage area in which the data D is stored is the address L3.

In addition, as described above, the data B and C is stored in the RAM 24, which is the short-lived memory, because the data B and C has a low rewrite frequency. The physical address space 153 of the short-lived memory has an address S1, an address S2, an address S3, an address S4, an address S5, . . . Here, it is assumed that the physical address which specifies the storage area in which the data B is stored is the address S1 and the physical address which specifies the storage area in which the data C is stored is the address S2.

At this time, in the page table 104, information for associating the address V2 of the virtual address space 152 and the address L2 of the physical address space 153, the address V3 of the virtual address space 152 and the address S1 of the physical address space 154, the address V4 of the virtual address space 152 and the address S2 of the physical address space 154, and the address V5 of the virtual address space 152 and the address L3 of the physical address space 153 is described.

Because data of which the rewrite frequency is high is stored in the long-lived memory and data of which the rewrite frequency is low is stored in the short-lived memory as described above, the entire life of the RAMs 23 and 24 can be lengthened. As described above, it is possible to more efficiently use the memory.

Incidentally, it is necessary to prepare management information for managing the number of rewrites or the like so that the remaining life of each storage area within the memory is known in the system using the memory having the rewrite life. The above-described management information is normally added for every page, which is a storage unit or management unit of the memory. For example, when one page is 100 KB, a storage area of a memory of 100 MB is allocated to 1000 pages and managed.

However, for example, if the capacity per page is the same when the memory has a large capacity, the number of pages is increased and management information is also increased. In such a case, the management cost easily increases.

Therefore, for example, the capacity per page may be changed according to a rewrite frequency of data.

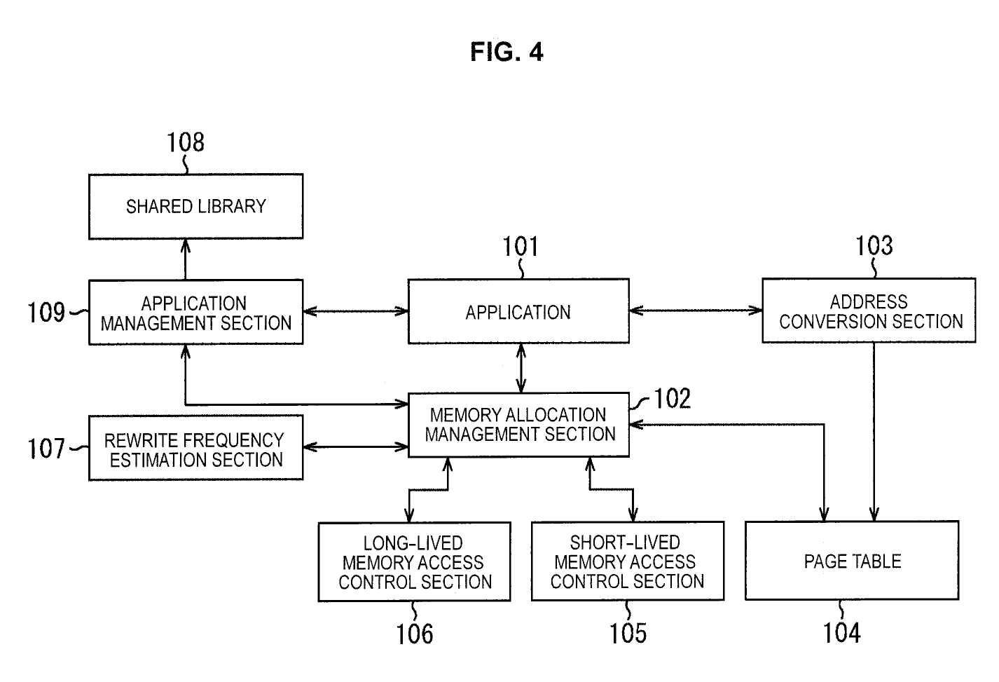

FIG. 4 is a block diagram illustrating another functional configuration example of software such as a program to be executed by the CPU 21 and the MMU 22 of FIG. 1. In the example of FIG. 4, the capacity per page is set to be changed according to a rewrite frequency of data.

In FIG. 4, an application management section 109 is configured to execute a process of loading a system shared file stored in an auxiliary storage apparatus or the like as a shared library 108, a file included a program, or the like to the primary storage apparatus. At this time, the application management section 109 maps data included in each file to a virtual address space.

Also, in data included in each file of the shared library 108, a label representing a rewrite frequency is assumed to be added to a header or the like of data in advance. Here, the label represents whether the rewrite frequency is zero (read-only data), low, or high.

When the data included in each file is mapped to the virtual address space, the application management section 109 specifies the rewrite frequency by referring to each header of the data or the like. Therefore, the application management section 109 notifies the memory allocation management section 102 of the specified rewrite frequency.

When the rewrite frequency of the notification from the application management section 109 is high, the memory allocation management section 102 allocates the storage area of the data to the RAM 23, which is the long-lived memory. Therefore, the memory allocation management section 102 causes the RAM 23 to store the data via the long-lived memory access control section 106.

At this time, the memory allocation management section 102 sets a page size of the storage area allocated to the RAM 23 to a small size.

In addition, when the rewrite frequency of the notification from the application management section 109 is zero or low, the memory allocation management section 102 allocates the storage area of the data to the RAM 24, which is the short-lived memory. Therefore, the memory allocation management section 102 causes the RAM 24 to store the data via the short-lived memory access control section 105.

At this time, the memory allocation management section 102 sets the page size of the storage area allocated to the RAM 24 to a large size.

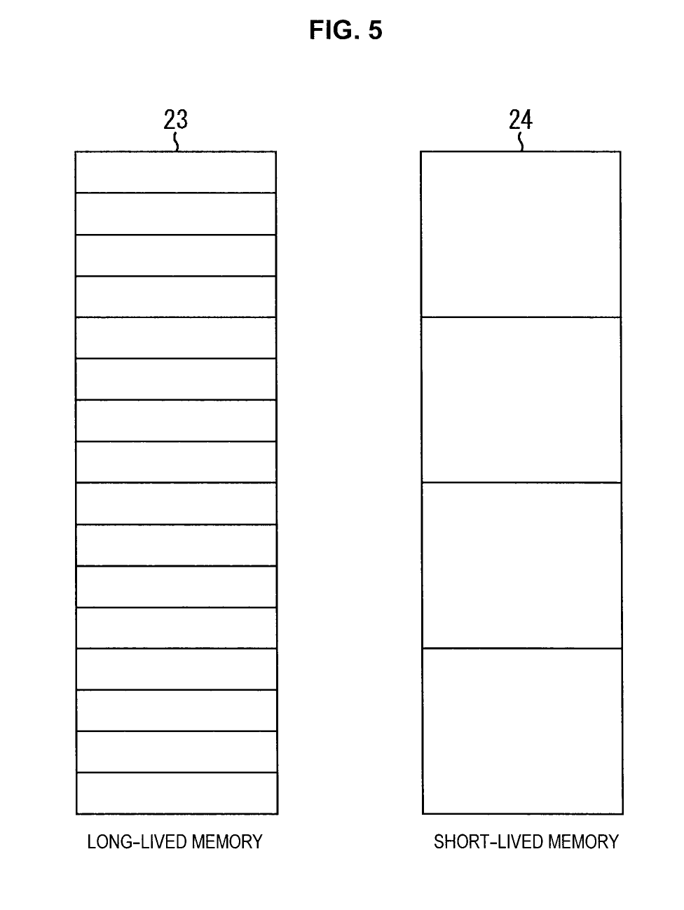

That is, for example, as illustrated in FIG. 5, the page size of the RAM 23, which is the long-lived memory, is set to be small, and the page size of the RAM 24, which is the short-lived memory, is set to be large. In FIG. 5, each small rectangle within a rectangle representing the RAM 23 or 24 represents a page size.

Because configurations of other parts in FIG. 4 are substantially the same as described above with reference to FIG. 2, detailed description thereof is omitted.

For example, when the page size is set to be small, it is possible to more efficiently use a storage capacity of a memory. This is because a storage capacity to be used can be decreased and the storage capacity to be used in one rewrite operation can be sufficiently decreased when small-sized data is written. That is, if the page size is set to be small, for example, when small-sized data is rewritten many times, the storage capacity to be used in one rewrite operation can be sufficiently decreased and a memory having a rewrite life can be used as long as possible.

On the other hand, when the page size is set to be small, a processing burden in the calculation processing system 10 is increased. This is because it is necessary to prepare management information or the like for managing the number of rewrites so that the remaining life of each storage area within the memory is known in the system using the memory having the rewrite life, and the above-described management information is normally added for every page, which is the storage unit of the memory.

For example, when the page size is set to be large, it is difficult to more efficiently use a storage capacity of a memory. This is because it is difficult to decrease a storage capacity to be used and it is difficult to sufficiently decrease the storage capacity to be used in one rewrite operation even when small-sized data is written. That is, if the page size is set to be large, for example, when small-sized data is rewritten many times, the storage capacity to be used in one rewrite operation is also increased and it is difficult to use a memory having a rewrite life for a long time.

When the rewrite frequency is high in the present technology, the storage area of the data is allocated to the long-lived memory and the page size is set to be small. Thereby, for example, when small-sized data is rewritten many times, the storage capacity to be used in one rewrite operation can be sufficiently decreased and a memory having a rewrite life can be used as long as possible.

In addition, when the rewrite frequency is zero or low in the present technology, the storage area of the data is allocated to the short-lived memory and the page size is set to be large. Thereby, even when small-sized data is written, it is difficult to decrease the storage capacity to be used, but an influence on rewrite life is small because the rewrite frequency is zero or low. In addition, a storage area having the short-lived memory with a margin to a certain extent can also be allocated to the short-lived memory because a high density is easily formed and a large capacity is easily formed.

Therefore, the above-described management burden can be reduced by setting a large page size.

In this present technology as described above, it is possible to efficiently use the entire memory including a long-lived memory and a short-lived memory.

Incidentally, although the data rewrite frequency is specified based on the label in the above-described example, for example, the data rewrite frequency may be specified by learning.

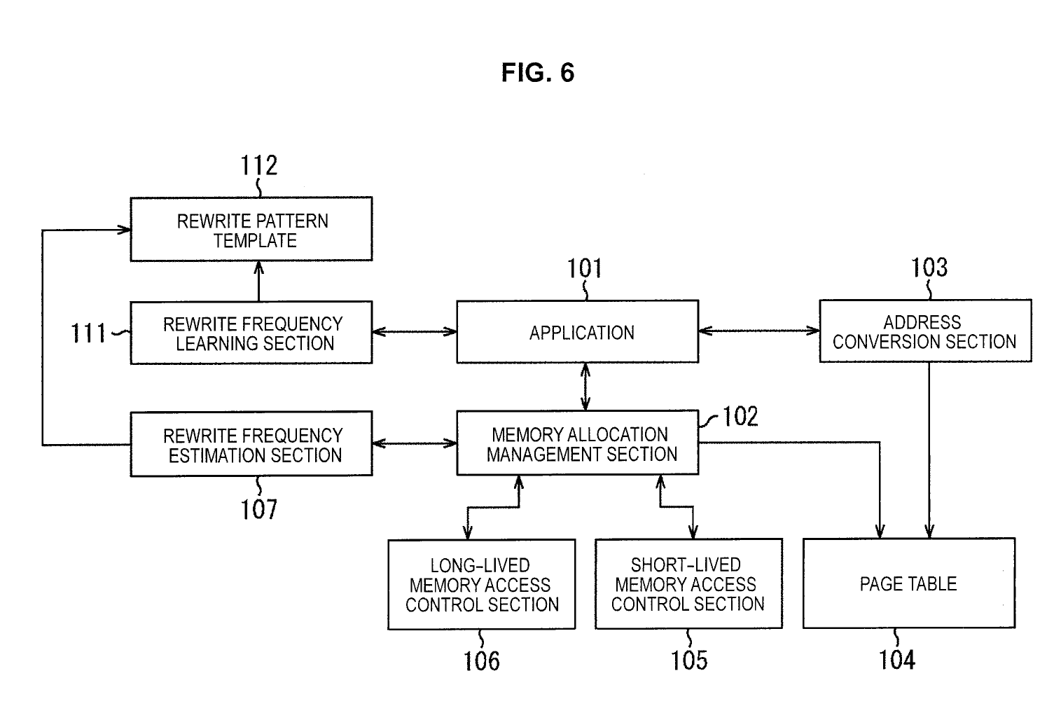

FIG. 6 is a block diagram illustrating still another functional configuration example of software such as a program to be executed by the CPU 21 and the MMU 22 of FIG. 1. In the example of FIG. 6, the data rewrite frequency is set to be specified by learning.

For example, in general, a type of data to which various parameters such as management information have been added is defined in addition to raw data obtainable from a sensor for sensing data output from the sensor or the like, and the sensing data is handled in a unit of the data type. Normally, the raw data obtainable from the sensor is not rewritten, but management information or the like may be frequently rewritten. In this case, a storage area for a part to be frequently rewritten in the data type is set to be allocated to the long-lived memory, and a storage area for a part to be rarely rewritten is set to be allocated to the short-lived memory.

A rewrite frequency learning section 111 is set to identify a data type of data stored in the RAM 23 or 24 and learn the rewrite frequency for every data type. The rewrite frequency learning section 111, for example, monitors the rewrite frequency of each part (for example, each page) of a predetermined data type of data stored in the RAM 23 or 24. Therefore, the rewrite frequency learning section 111, for example, specifies the rewrite frequency of each part to a zero, large, or small value, and generates information representing the rewrite frequency of each part of the data type as a rewrite pattern template 112. That is, a plurality of rewrite pattern templates 112 are generated for every data type.

When a storage area of data for which writing has been requested from the application 101 is allocated to the RAM 23 or 24, the memory allocation management section 102 queries the rewrite frequency estimation section 107 for the rewrite frequency. The rewrite frequency estimation section 107 specifies a data type of data for which writing has been requested by receiving the query from the memory allocation management section 102, and searches for a rewrite pattern template 112 corresponding to the data type.

When there is a rewrite pattern template 112 corresponding to the data type of data for which writing has been requested, the rewrite frequency estimation section 107 specifies the rewrite frequency of each part of the data for which writing has been requested based on the rewrite pattern template 112 and notifies the memory allocation management section 102 of the specified rewrite frequency.

On the other hand, when there is a rewrite pattern template 112 corresponding to the data type of data for which writing has been requested, the rewrite frequency estimation section 107 sets the rewrite frequency of each part of the data for which writing has been requested to a large value and notifies the memory allocation management section 102 of the set rewrite frequency.

The memory allocation management section 102 allocates a storage area for a part of which the rewrite frequency of the notification from the rewrite frequency estimation section 107 is large to the RAM 23, which is the long-lived memory. Therefore, the memory allocation management section 102 causes the RAM 23 to store the part via the long-lived memory access control section 106.

In addition, the memory allocation management section 102 allocates a storage area for a part of which the rewrite frequency of the notification from the rewrite frequency estimation section 107 is zero or small to the RAM 24, which is the short-lived memory. Therefore, the memory allocation management section 102 causes the RAM 24 to store the part via the short-lived memory access control section 105.

Because configurations of other parts in FIG. 6 are substantially the same as described above with reference to FIG. 2, detailed description thereof is omitted.

As described above, the data rewrite frequency can be specified by learning.

Incidentally, data temporarily stored in the RAM 24 (or the RAM 23) may be set to be moved to the RAM 23 (or the RAM 24) thereafter.

For example, there is data to be rarely rewritten at normal times, but to be frequently rewritten in a specific step or routine within a program such as error processing among data to be processed by the application 101. If the above-described data is stored in the short-lived memory at normal times, and moved to the long-lived memory only when the above-described data is executed in the specific step or routine within the program, the entire memory can be efficiently used.

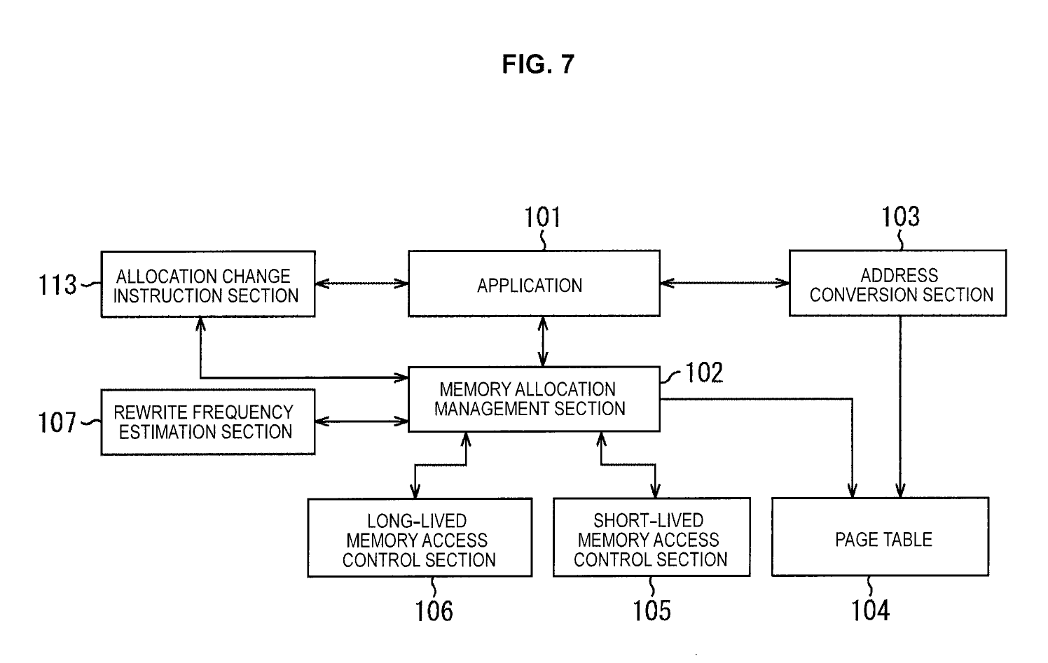

FIG. 7 is a block diagram illustrating still another functional configuration example of software such as a program to be executed by the CPU 21 and the MMU 22 of FIG. 1. In the example of FIG. 7, data temporarily stored in the RAM 24 (or the RAM 23) may be set to be moved to the RAM 23 (or the RAM 24) thereafter.

In FIG. 7, within the program of the application 101, for example, a specific step or routine corresponding to error processing or the like is assumed to be designated in advance. In addition, data to be frequently rewritten is also assumed to be designated in advance when the specific step or routine is executed. The data to be frequently rewritten when the specific step or routine is executed is referred to as data to be rewritten for a specific time. The data to be rewritten for the specific time is normally stored in the short-lived memory (RAM 24).

When the specific step or routine is executed, the application 101 notifies an allocation change instruction section 113 of the above-described fact.

Upon receipt of the notification that the specific step or routine is executed, the allocation change instruction section 113 controls the movement of the data to be rewritten for the specific time. That is, upon receipt of the notification that the specific step or routine is executed, the allocation change instruction section 113 requests the memory allocation management section 102 to move the data to be rewritten for the specific time to the long-lived memory (RAM 23).

Upon receipt of the request from the allocation change instruction section 113, the memory allocation management section 102 causes the data to be rewritten for the specific time stored in the short-lived memory (RAM 24) to be moved to the long-lived memory (RAM 23).

In addition, at this time, the memory allocation management section 102 updates information of the page table 104 so as to associate a physical address, which specifies a storage area for the data to be rewritten for the specific time allocated to the RAM 24, and a virtual address to be referred to by the application 101.

Further, the application 101 notifies the allocation change instruction section 113 of the above-described fact when the execution of the specific step or routine ends.

Upon receipt of the notification that the execution of the specific step or routine ends, the allocation change instruction section 113 controls the movement of the data to be rewritten for the specific time. That is, upon receipt of the notification that the execution of the specific step or routine ends, the allocation change instruction section 113 requests the memory allocation management section 102 to move the data to be rewritten for the specific time to the short-lived memory (RAM 24).

Upon receipt of the request from the allocation change instruction section 113, the memory allocation management section 102 causes the data to be rewritten for the specific time stored in the long-lived memory (RAM 23) to be moved to the short-lived memory (RAM 24).

In addition, at this time, the memory allocation management section 102 updates information of the page table 104 so as to associate a physical address, which specifies a storage area for the data to be rewritten for the specific time allocated to the RAM 23, and a virtual address to be referred to by the application 101.

Because configurations of other parts in FIG. 7 are substantially the same as described above with reference to FIG. 2, detailed description thereof is omitted.

As described above, the data to be rewritten for the specific time is stored in the short-lived memory at normal times, and moved to the long-lived memory only when the specific step or routine is executed.

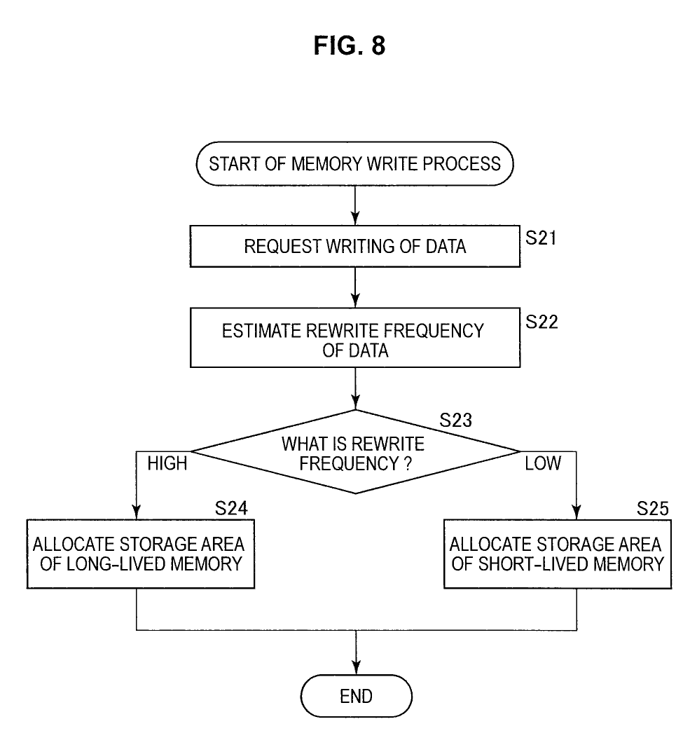

Next, an example of the memory write process by the calculation processing system 10 to which the present technology has been applied will be described with reference to the flowchart of FIG. 8. This process, for example, is a process corresponding to the functional configuration described above with reference to FIG. 2.

In step S21, the application 101 outputs a write request to the memory allocation management section 102 so as to write a file generated during processing to the RAM 23 or 24. At this time, the application 101, for example, is set to add a label related to a data rewrite frequency to a header of data included in the file or the like.

Thereby, the memory allocation management section 102 queries the rewrite frequency estimation section 107 for the rewrite frequency so as to determine to which of the RAM 23 and the RAM 24 a data storage area is allocated.

In step S22, the rewrite frequency estimation section 107 estimates whether the data rewrite frequency is high or low by referring to the label added to the data header. The memory allocation management section 102 is notified of the estimation result.

In step S23, the memory allocation management section 102 determines the data rewrite frequency based on the estimation result of step S22.

When the data rewrite frequency is determined to be large in step S23, the process proceeds to step S24.

In step S24, the memory allocation management section 102 allocates the data storage area to the RAM 23, which is the long-lived memory. Therefore, the memory allocation management section 102 causes the RAM 23 to store the data via the long-lived memory access control section 106.

On the other hand, when the data rewrite frequency is determined to be low in step S23, the process proceeds to step S25.

In step S25, the memory allocation management section 102 allocates the data storage area to the RAM 24, which is the short-lived memory. Therefore, the memory allocation management section 102 causes the RAM 24 to store the data via the short-lived memory access control section 105.

Also, the memory allocation management section 102 updates information of the page table 104 in which a physical address, which specifies the data storage area allocated as described above, and a virtual address to be referred to by the application 101 are associated.

Thereby, the memory write process is executed.

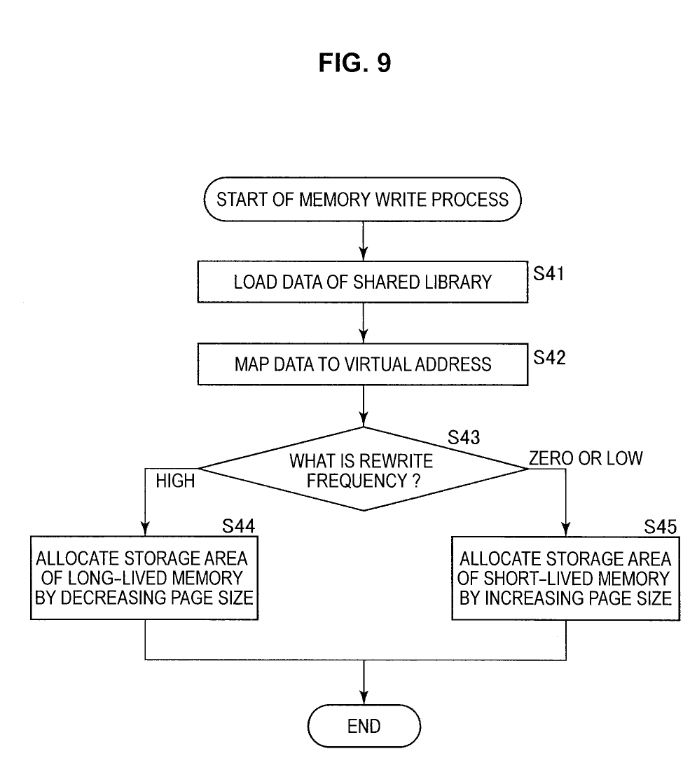

Next, another example of the memory write process by the calculation processing system 10 to which the present technology has been applied will be described with reference to the flowchart of FIG. 9. This process, for example, is a process corresponding to the functional configuration described above with reference to FIG. 4.

In step S41, the application management section 109 loads a system shared file stored in an auxiliary storage apparatus or the like as the shared library 108, a file included in the program, or the like to the primary storage apparatus.

In step S42, the application management section 109 maps data included in each file to a virtual address space.

Also, in the data included in each file of the shared library 108, the label representing the rewrite frequency is assumed to be added to a header or the like of the data. Here, the label, for example, is set to represent whether the rewrite frequency is zero (read-only data), low, or high.

In step S43, the application management section 109 determines the rewrite frequency by referring to each header or the like of the data. At this time, the application management section 109 notifies the memory allocation management section 102 of the determination result.

When the rewrite frequency is determined to be high in step S43, the process proceeds to step S44.

In step S44, the memory allocation management section 102 allocates the data storage area to the RAM 23, which is the long-lived memory. At this time, the memory allocation management section 102 sets a page size of the storage area allocated to the RAM 23 to a small size. Therefore, the memory allocation management section 102 causes the RAM 23 to store the data via the long-lived memory access control section 106.

On the other hand, when the rewrite frequency is determined to be low in step S43, the process proceeds to step S45.

In step S45, the memory allocation management section 102 allocates the data storage area to the RAM 24, which is the short-lived memory. At this time, the memory allocation management section 102 sets a page size of the storage area allocated to the RAM 24 to a large size. Therefore, the memory allocation management section 102 causes the RAM 24 to store the data via the short-lived memory access control section 105.

Also, the memory allocation management section 102 updates information of the page table 104 in which a physical address, which specifies the data storage area allocated as described above, and a virtual address to be referred to by the application 101 are associated.

Thereby, the memory write process is executed.

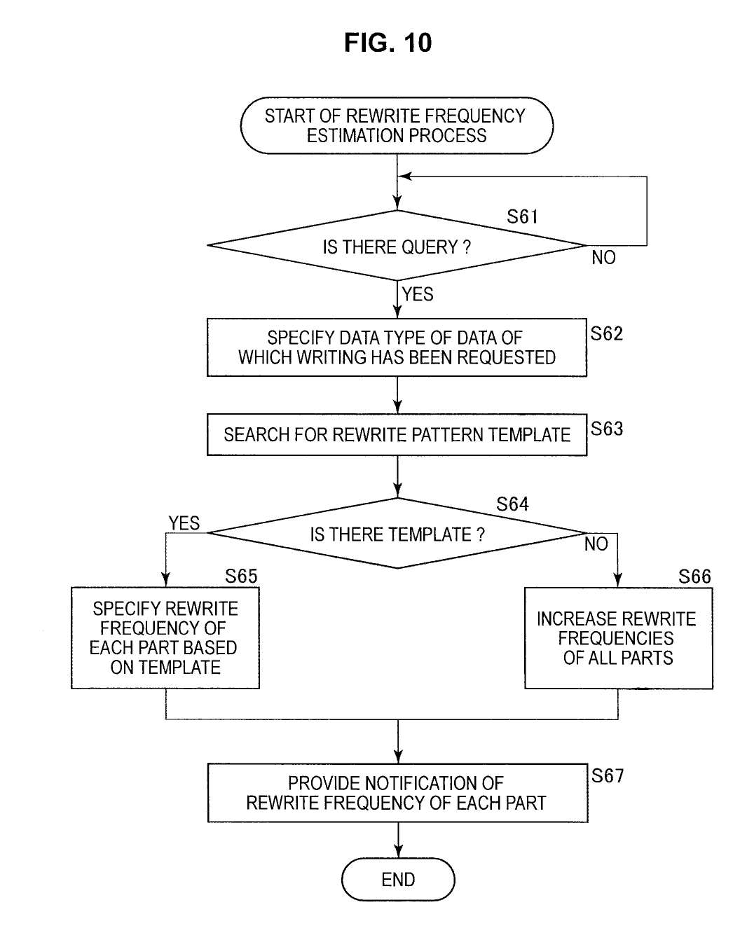

Next, an example of a rewrite frequency estimation process by the calculation processing system 10 to which the present technology has been applied will be described with reference to the flowchart of FIG. 10. This process is a process corresponding to the functional configuration described above with reference to FIG. 6, and, for example, is a process to be executed instead of the process of step S22 of FIG. 8

In this case, the rewrite frequency learning section 111 is set to identify a data type of data stored in the RAM 23 or 24 and learn the rewrite frequency for every data type. The rewrite frequency learning section 111, for example, specifies the rewrite frequency of each part to a zero, high, or low value by monitoring the rewrite frequency of each part (for example, each page) of a predetermined data type of data stored in the RAM 23 or 24. Therefore, information representing the rewrite frequency of each part of the data type is generated as a rewrite pattern template 112.

For example, when a storage area of data for which writing has been requested from the application 101 is allocated to the RAM 23 or 24, the memory allocation management section 102 queries the rewrite frequency estimation section 107 for the rewrite frequency. Thereby, the query is determined to be present in step S61, and the process proceeds to step S62.

In step S62, the rewrite frequency estimation section 107 specifies a data type of data for which writing has been requested.

In step S63, the rewrite frequency estimation section 107 searches for a rewrite pattern template 112 corresponding to the data type specified in the process of step S62.

In step S64, the rewrite frequency estimation section 107 determines whether there is a rewrite pattern template 112 corresponding to the data type based on the search result in the process of step S63.

When the rewrite pattern template 112 corresponding to the data type is determined to be present in step S64, the process proceeds to step S65.

In step S65, the rewrite frequency estimation section 107 specifies the rewrite frequency of each part of data for which writing has been requested based on the rewrite pattern template 112.

On the other hand, when the rewrite pattern template 112 corresponding to the data type is determined to be absent in step S64, the process proceeds to step S66.

In step S66, the rewrite frequency estimation section 107 sets the rewrite frequency of every part of the data for which writing has been requested to a large value.

In step S67, the rewrite frequency estimation section 107 notifies the memory allocation management section 102 of the specific result in the process of step S65 or S66.

Thereby, the rewrite frequency estimation process is executed.

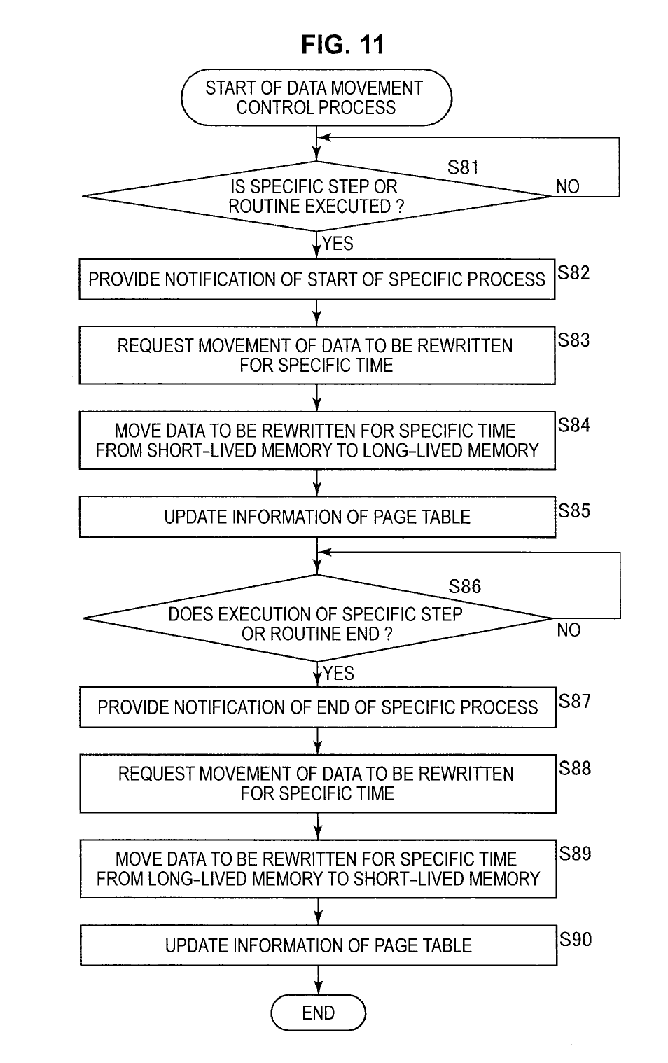

Next, an example of a data movement control process by the calculation processing system 10 to which the present technology has been applied will be described with reference to the flowchart of FIG. 11. This process, for example, is a process corresponding to the functional configuration described above with reference to FIG. 7.

In this case, within the program of the application 101, for example, a specific step or routine corresponding to error processing or the like is assumed to be designated in advance. In addition, when the specific step or routine is executed, data to be frequently rewritten (data to be rewritten for specific time) is assumed to be designated in advance. Also, the data to be rewritten for the specific time is assumed to be normally stored in the short-lived memory (RAM 24).

In step S81, the application 101 determines whether the specific step or routine is executed, and waits until the specific step or routine is determined to be executed.

When it is determined that the specific step or routine is executed in step S81, the process proceeds to step S82.

In step S82, the application 101 notifies the allocation change instruction section 113 that the specific step or routine is executed.

In step S83, the allocation change instruction section 113 requests the memory allocation management section 102 to move the data to be rewritten for the specific time to the long-lived memory (RAM 23).

In step S84, the memory allocation management section 102 causes the data to be rewritten for the specific time stored in the short-lived memory (RAM 24) to be moved to the long-lived memory (RAM 23).

In step S85, the memory allocation management section 102 updates information of the page table 104 so as to associate a physical address, which specifies a storage area for the data to be rewritten for the specific time allocated to the RAM 23, and a virtual address to be referred to by the application 101.

In step S86, the application 101 determines whether the execution of the specific step or routine ends, and waits until the execution of the specific step or routine ends.

When the execution of the specific step or routine is determined to end in step S86, the process proceeds to step S87.

In step S87, the application 101 notifies the allocation change instruction section 113 that the execution of the specific step or routine ends.

In step S88, the allocation change instruction section 113 requests the memory allocation management section 102 to move the data to be written for the specific time to the short-lived memory (RAM 24).

In step S89, upon receipt of the request from the allocation change instruction section 113, the memory allocation management section 102 causes the data to be rewritten for the specific time stored in the long-lived memory (RAM 23) to be moved to the short-lived memory (RAM 24).

In step S90, the memory allocation management section 102 updates information of the page table 104 so as to associate a physical address, which specifies a storage area for the data to be rewritten for the specific time allocated to the RAM 24, and a virtual address to be referred to by the application 101.

Thereby, the data movement control process is executed.

Although an example in which the long-lived memory and the short-lived memory are used as the primary storage apparatus has been described above, for example, a large-capacity short-lived memory may also be used as the auxiliary storage apparatus.

In addition, although an example in which the short-lived memory and the long-lived memory are configured by a nonvolatile memory has been described above, for example, the long-lived memory may be configured by a volatile memory such as a DRAM. In short, the present technology is applicable to any system using a combination of memories each having a different rewrite life as the primary storage apparatus.

Further, although an example in which the primary storage apparatus is configured by combining two memories of the RAM 23 and the RAM 24 has been described above, the primary storage apparatus may be configured by combining three or more memories.

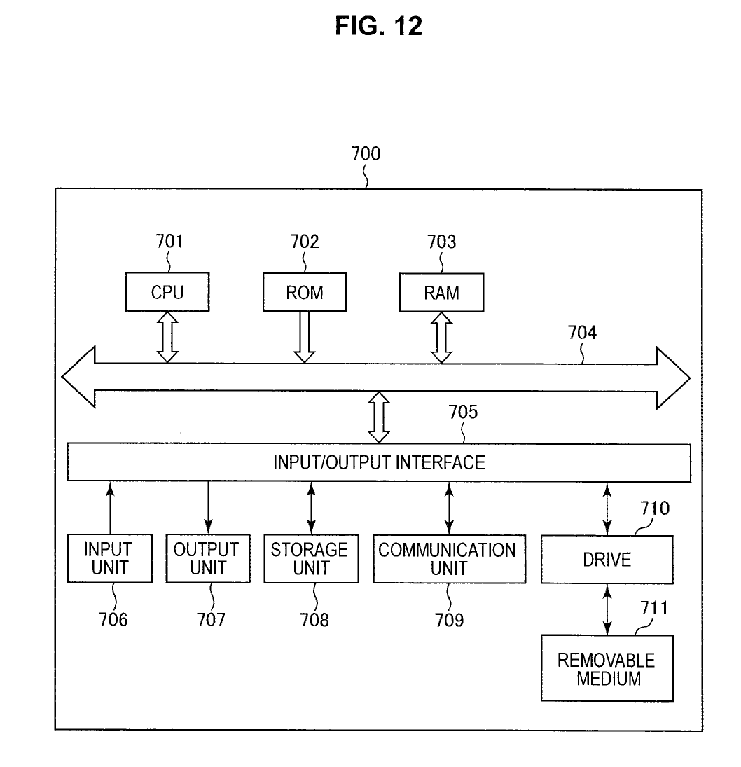

The series of processes described above can be realized by hardware or software. When the series of processes is executed by the software, a program forming the software is installed in a computer embedded in dedicated hardware and a general-purpose PC 700 illustrated in FIG. 12 in which various programs can be installed and various functions can be executed, through a network or a recording medium.

In FIG. 12, a CPU 701 executes various processes according to a program stored in a read only memory (ROM) 702 or a program loaded from a storage section 708 to a RAM 703. In the RAM 703, data that is necessary for executing the various processes by the CPU 701 is appropriately stored.

The CPU 701, the ROM 702, and the RAM 703 are connected mutually by a bus 704. Also, an input/output interface 705 is connected to the bus 704.

An input section 706 that includes a keyboard and a mouse, an output section 707 that includes a display composed of a liquid crystal display (LCD) and a speaker, a storage section 708 that is configured using a hard disk, and a communication section 709 that is configured using a modem and a network interface card such as a LAN card are connected to the input/output interface 705. The communication section 709 executes communication processing through a network including the Internet.

A drive 710 is connected to the input/output interface 705 according to necessity, removable media 711 such as a magnetic disk, an optical disc, a magneto optical disc, or a semiconductor memory are appropriately mounted, and a computer program that is read from the removable media 711 is installed in the storage section 708 according to necessity.

When the series of processes is executed by the software, a program forming the software is installed through the network such as the Internet or a recording medium composed of the removable media 711.

The recording medium may be configured using the removable media 711 illustrated in FIG. 12 that is composed of a magnetic disk (including a floppy disk (registered trademark)), an optical disc (including a compact disc-read only memory (CD-ROM) and a digital versatile disc (DVD)), a magneto optical disc (including a mini-disc (MD) (registered trademark)), or a semiconductor memory, which is distributed to provide a program to a user and has a recorded program, different from a device body, and may be configured using a hard disk that is included in the ROM 702 provided to the user in a state embedded in the device body in advance having a recorded program or the storage section 708.

In the present disclosure, the series of processes includes a process that is executed in the order described, but the process is not necessarily executed temporally and can be executed in parallel or individually.

The embodiment of the present technology is not limited to the above-described embodiment. It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.
(1) An information processing apparatus including:

a primary storage apparatus configured by combining a plurality of memories each having a different upper limit of a number of possible rewrites; and an allocation management section configured to allocate a storage area of data to be stored in the primary storage apparatus to one of the plurality of memories based on a rewrite frequency of the data.
(2) The information processing apparatus according to (1),
   wherein the allocation management section allocates a storage area of data having a high rewrite frequency to a first memory of the plurality of memories, and
   wherein the allocation management section allocates a storage area of data having a low rewrite frequency to a second memory having a smaller upper limit of the number of possible rewrites than the first memory of the plurality of memories.
(3) The information processing apparatus according to (2), wherein the allocation management section sets a storage capacity per page of the second memory to be larger than a storage capacity per page of the first memory.
(4) The information processing apparatus according to (2), wherein the second memory has a larger storage capacity than the first memory.
(5) The information processing apparatus according to (2), wherein the first memory is a magnetoresistive random access memory (MRAM), and
   wherein the second memory is a resistance random access memory (ReRAM) or a phase change memory (PCM).
(6) The information processing apparatus according to any one of (1) to (5), further including:
   a rewrite frequency estimation section configured to estimate a rewrite frequency of data to be stored in the primary storage apparatus based on additional information of the data.
(7) The information processing apparatus according to any one of (1) to (6), wherein the rewrite frequency estimation section estimates a rewrite frequency of a part included in data to be stored in the primary storage apparatus for a data type of the data.
(8) The information processing apparatus according to (7), wherein the rewrite frequency of the part included in the data is estimated based on a template generated by learning for the data type of the data.
(9) The information processing apparatus according to any one of (1) to (8), further including:
   a specific step execution notification section configured to notify the allocation management section that a specific step is executed when a process of the specific step designated in advance is executed in a program to be executed by a central processing unit (CPU),
   wherein, when a notification has been received from the execution notification section, the allocation management section allocates the storage area of the data allocated to one memory of the plurality of memories to another memory of the plurality of memories.
(10) The information processing apparatus according to (9), wherein, when the notification has been received from the execution notification section, the allocation management section allocates a storage area of data stored in the second memory having a smaller upper limit of the number of possible rewrites than the first memory of the plurality of memories, to the first memory.
(11) The information processing apparatus according to any one of (1) to (10), wherein a memory having a relatively small upper limit of the number of possible rewrites of the plurality of memories is also used as an auxiliary storage apparatus.
(12) The information processing apparatus according to any one of (1) to (11), wherein a memory having a relatively small upper limit of the number of possible rewrites of the plurality of memories is configured as a nonvolatile memory, and
   wherein a memory having a relatively large upper limit of the number of possible rewrites of the plurality of memories is configured as a volatile memory.
(13) An information processing method of an information processing apparatus including a primary storage apparatus configured by combining a plurality of memories each having a different upper limit of a number of possible rewrites, the information processing method including:
   allocating a storage area of data to be stored in the primary storage apparatus to one of the plurality of memories based on a rewrite frequency of the data.
(14) A program for causing a computer to function as an information processing apparatus, the information processing apparatus including
   a primary storage apparatus configured by combining a plurality of memories each having a different upper limit of a number of possible rewrites, and
   an allocation management section configured to allocate a storage area of data to be stored in the primary storage apparatus to one of the plurality of memories based on a rewrite frequency of the data.
(15) A non-transitory computer readable medium having a computer readable instructions stored thereon that when executed by an information processing apparatus including a primary storage apparatus configured by combining a plurality of memories each having a different upper limit of a number of possible rewrites perform a method, the method including:
   allocating a storage area of data to be stored in the primary storage apparatus to one of the plurality of memories based on a rewrite frequency of the data.

The present disclosure contains subject matter related to that disclosed in Japanese Priority Patent Application JP 2012-130397 filed in the Japan Patent Office on Jun. 8, 2012, the entire content of which is hereby incorporated by reference.

What is claimed is:

1. An information processing apparatus comprising:
a primary storage apparatus configured by combining a plurality of memories each having a different upper limit of a number of possible rewrites; and
an allocation management section configured to allocate a storage area of data to be stored in the primary storage apparatus to one of the plurality of memories based on a rewrite frequency of the data.

2. The information processing apparatus according to claim 1,
wherein the allocation management section allocates a storage area of data having a high rewrite frequency to a first memory of the plurality of memories, and
wherein the allocation management section allocates a storage area of data having a low rewrite frequency to a second memory having a smaller upper limit of the number of possible rewrites than the first memory of the plurality of memories.

3. The information processing apparatus according to claim 2, wherein the allocation management section sets a storage capacity per page of the second memory to be larger than a storage capacity per page of the first memory.

4. The information processing apparatus according to claim 2, wherein the second memory has a larger storage capacity than the first memory.

5. The information processing apparatus according to claim 2,
wherein the first memory is a magnetoresistive random access memory (MRAM), and
wherein the second memory is a resistance random access memory (ReRAM) or a phase change memory (PCM).

6. The information processing apparatus according to claim 1, further comprising:
a rewrite frequency estimation section configured to estimate a rewrite frequency of data to be stored in the primary storage apparatus based on additional information of the data.

7. The information processing apparatus according to claim 1, wherein the rewrite frequency estimation section estimates a rewrite frequency of a part included in data to be stored in the primary storage apparatus for a data type of the data.

8. The information processing apparatus according to claim 7, wherein the rewrite frequency of the part included in the data is estimated based on a template generated by learning for the data type of the data.

9. The information processing apparatus according to claim 1, further comprising:
a specific step execution notification section configured to notify the allocation management section that a specific step is executed when a process of the specific step designated in advance is executed in a program to be executed by a central processing unit (CPU),
wherein, when a notification has been received from the execution notification section, the allocation management section allocates the storage area of the data allocated to one memory of the plurality of memories to another memory of the plurality of memories.

10. The information processing apparatus according to claim 9, wherein, when the notification has been received from the execution notification section, the allocation management section allocates a storage area of data stored in the second memory having a smaller upper limit of the number of possible rewrites than the first memory of the plurality of memories, to the first memory.

11. The information processing apparatus according to claim 1, wherein a memory having a relatively small upper limit of the number of possible rewrites of the plurality of memories is also used as an auxiliary storage apparatus.

12. The information processing apparatus according to claim 1,
wherein a memory having a relatively small upper limit of the number of possible rewrites of the plurality of memories is configured as a nonvolatile memory, and
wherein a memory having a relatively large upper limit of the number of possible rewrites of the plurality of memories is configured as a volatile memory.

13. An information processing method of an information processing apparatus including a primary storage apparatus configured by combining a plurality of memories each having a different upper limit of a number of possible rewrites, the information processing method comprising:
allocating a storage area of data to be stored in the primary storage apparatus to one of the plurality of memories based on a rewrite frequency of the data.

14. A non-transitory computer readable medium having a computer readable instructions stored thereon that when executed by an information processing apparatus including a primary storage apparatus configured by combining a plurality of memories each having a different upper limit of a number of possible rewrites perform a method, the method comprising:
allocating a storage area of data to be stored in the primary storage apparatus to one of the plurality of memories based on a rewrite frequency of the data.
